(19) United States
(12) Patent Application Publication
(10) Pub. No.: US 2008/0119150 A1
(43) Pub. Date: May 22, 2008

(54) MULTI-ANTENNA RECEIVER USING SINGLE TUNER AND METHOD THEREOF

(75) Inventor: Wen-Lin Su, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SPEED TECH CORP., Taoyuan Hsien (TW)

(21) Appl. No.: 11/560,841

(22) Filed: Nov. 17, 2006

(51) Int. Cl. H04B 1/18

(52) U.S. Cl. 455/193.1

(57) ABSTRACT

A multi-antenna receiver using single tuner and method thereof are disclosed. By using single tuner, a multi-channel switch, a demodulator and an antenna-selecting mechanism, the receiver will be able to choose a signal, whose quality can meet the quality requirement, from multiple signals received by multiple antennas. By the present invention, not only the quality requirement for the received signals is met, but also the circuit size and the power assumption of the multi-antenna receiver are reduced.

### BACKGROUND OF THE INVENTION

1. Field of Invention

The present invention generally relates to a multi-antenna communication receiver, and more particular, to a wireless communication receiver using a single tuner.

2. Description of Related Art

With the conventional manner of receiving wireless signals by a single antenna, the user often needs to adjust the position and orientation of the single antenna to improve the quality of received signals when the reception quality is not satisfied. As a result however, it causes a lot of inconvenience to the user. In the case where it is not easy to change the position and orientation of the antenna as desire, the single antenna architecture would have low signal reception quality, which is counted as the drawback of the single antenna architecture.

To overcome the above-described problem, in a wireless communication, for example, in a digital video broadcast-terrestrial system (DVB-T system), multiple antennas are used to enhance the reception efficiency, which is termed as antenna diversity. With the antenna diversity scheme, the receiver is equipped with two or more antennas for receiving the signals. It is assumed that the antenna diversity herein includes N pieces of antennas (N is an integer greater than 1). FIG. 1 is the block diagram of a conventional wireless communication receiver using the antenna diversity scheme. Referring to FIG. 1, multiple antennas 101-1˜101-N are respectively one-to-one coupled to the corresponding tuners 103-1˜103-N. The output signals of the tuners can be intermediate frequency (IF) signals or inphase/quadrature (I/Q) signals. The outputs of the tuners are coupled to a combiner 105, which is responsible for respectively weighting the different signals received by the antennas and combining the weighted signals. The output from the combiner 105 is coupled to a demodulator 107, and the demodulator 107 outputs a transport stream (TS) to a decoder (not shown in FIG. 1) for decoding.

It can be seen from the above described, a receiver adopting the above-mentioned antenna diversity scheme requires a plurality of tuners, which would increase the circuit complexity. In addition, the scheme employs a plurality of components, which costs more, requires a bigger printed circuit board (PCB) area and consumes more power. Therefore, the relevant prior art is not suitable for an electricity-saving and portable device.

### SUMMARY OF THE INVENTION

Accordingly, an aspect of the present invention is to provide a multi-antenna wireless communication receiver using a single tuner, which is suitable for a wireless communication receiver, for example, a DVB-T receiver.

Another aspect of the present invention is to provide a multi-antenna wireless communication receiver with low cost and less circuit area for effectively enhancing the coverage range.

Another yet aspect of the present invention is to provide a multi-antenna wireless communication receiver suitable for a mobile electronic device or portable electronic device.

To achieve the above-mentioned aspects, the present invention provides a wireless communication receiver, which includes a multi-channel switch (MS), a tuner and a demodulator. N pieces of antennas (N is an integer greater than 1) are coupled to the MS, and the MS selects one of the signals received by the antennas for output. The MS output is coupled to the tuner, while the output signal of the tuner can be an IF signal or an I/Q signal. The tuner output is coupled to the demodulator and the demodulator outputs a transport stream available for a next-stage decoder to decode. The demodulator can further feed a control signal back to the MS to select one of the signals received by the antennas.

The demodulator is able to monitor bit error rate (BER) and, according to the detected BER, judges whether the quality of the signal received by the antenna the MS selects meets the quality requirement. For example, in DVB-T communication, the quality requirement can mean, but not limited to, that based on the transport stream output from the demodulator, the next-stage decoder may recover the originally transmitted frames. If it fails to meet the quality requirement, the demodulator would use the control signal to make the MS select the signal received by another antenna until the signal quality requirement is met. In order to select the quality-qualified signal received by an antenna, the MS would be controlled so that, for example but not limited to, the signals received by all the antennas may be sequentially selected.

Further, the present invention provides a multi-antenna wireless communication receiving method using a single tuner. The method includes the following steps: selecting the default antenna by a MS to receive the signal; performing tuning and demodulating on the signal received by the antenna; continuously monitoring the quality of the received signal and judging whether the signal meets the quality requirement; if the quality of the received signal meets the quality requirement, keeping the signal received by the antenna to be use in decoding; if the quality of the received signal does not meet the quality requirement, controlling the MS to select signals received by other antennas.

In summary, the present invention provides a multi-antenna wireless communication receiver using a single tuner and the method thereof, wherein the benefit of the proposed multi-antenna scheme with single tuner are closed to that of the prior multi-antenna scheme with multiple tuners. Moreover, the present invention is capable of reducing the receiver size and lowering the power-consumption of the receiver. Therefore, the present invention has overwhelming advantages for a wireless communication device to adapt the trend of portability, miniaturization and power-conservation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a conventional wireless communication receiver.

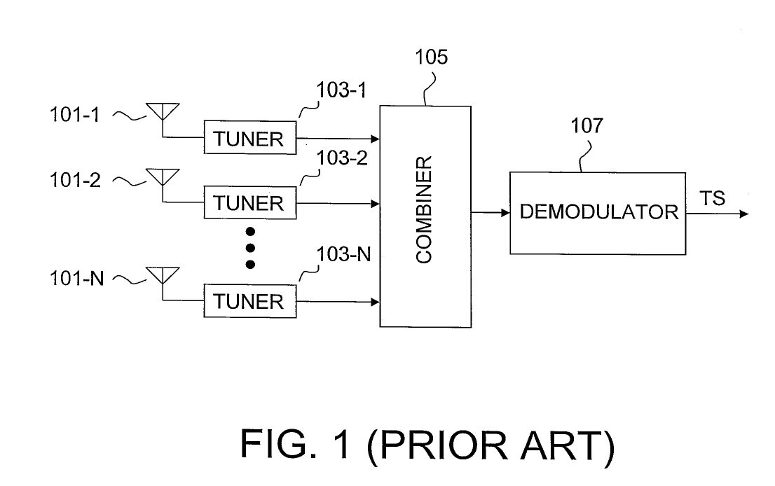

FIG. 2 is the block diagram of a wireless communication receiver according to a preferred embodiment of the present invention.

FIG. 3 is the flowchart of the wireless communication receiving method according to the preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

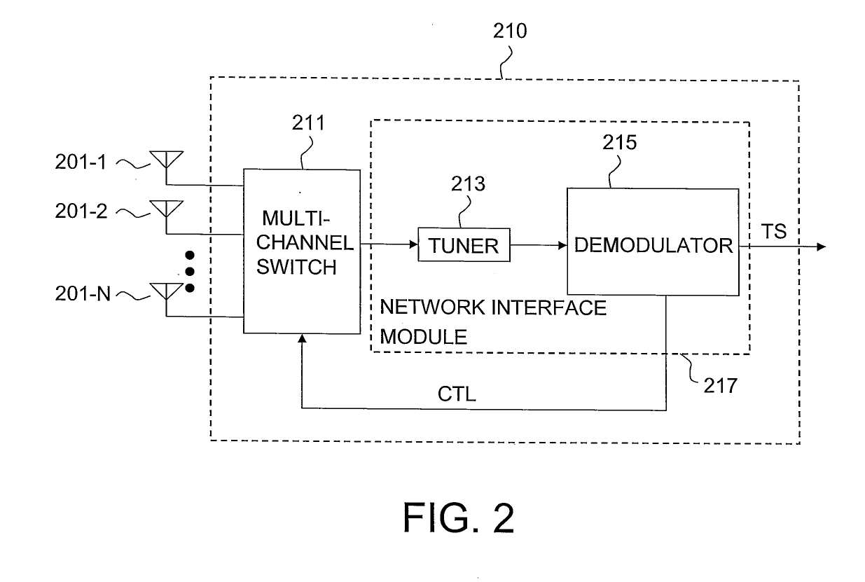

FIG. 2 is the block diagram of a wireless communication receiver according to an embodiment of the present invention, which may be applicable in a DVB-T system. Referring to FIG. 2, the wireless communication receiver 210 includes a multi-channel switch (MS) 211, a tuner 213 and a demodulator 215, wherein the tuner 213 and the demodulator 215 are included in a network interface module (NIM) 217.

In addition, N antennas 201-1˜201-N (N is an integer greater than 1) are coupled to the MS 211, and the MS 211 selects one of the signals received by the antennas 201-1˜201-N for output according to a control signal CTL come from the demodulator 215. The output of the MS 211 is coupled to the tuner 213, and the tuner 213 tunes the input signal and outputs the tuned signal. The output signal of the tuner 213 can be an intermediate frequency (IF) signal or an inphase/quadrature (I/Q) signal. The output of the tuner 213 is coupled to the demodulator 215 for performing a demodulating operation. The output of the demodulator 215 is a transport stream (TS) provided to a next-stage decoder (not shown in FIG. 2) for decoding. The demodulator 215 can further feed the control signal CTL back, so as to control the MS 211 selecting one of the signals received by the antennas 201-1˜201-N for output.

The demodulator 215 is able to monitor bit error rate (BER). The detail implementation manner of the BER-monitoring function is not particularly specified herein, as long as the function works to achieve the goal of the present invention. The demodulator 215 judges whether the signal quality received by the antenna the MS 211 selects meets the quality requirement according to the detected BER. For example, in DVB-T communication, the quality requirement may mean, but not limited to, that based on the transport stream output from the demodulator 215, the next-stage decoder (not shown in FIG. 2) recover the originally transmitted frames.

If the received signal from the selected antenna fails to meet the quality requirement, the demodulator 215 would use the control signal CTL to make the MS 211 select the signal received by another antenna until the signal quality requirement is met. In order to select the quality-qualified signal received by an antenna, the MS 211 would be controlled so that, for example, but not limited to, sequentially selecting the signals received by the N antennas may be selected in a sequence, from the first antenna 201-1, then the second antenna 201-2, until the N-th antenna 201-N.

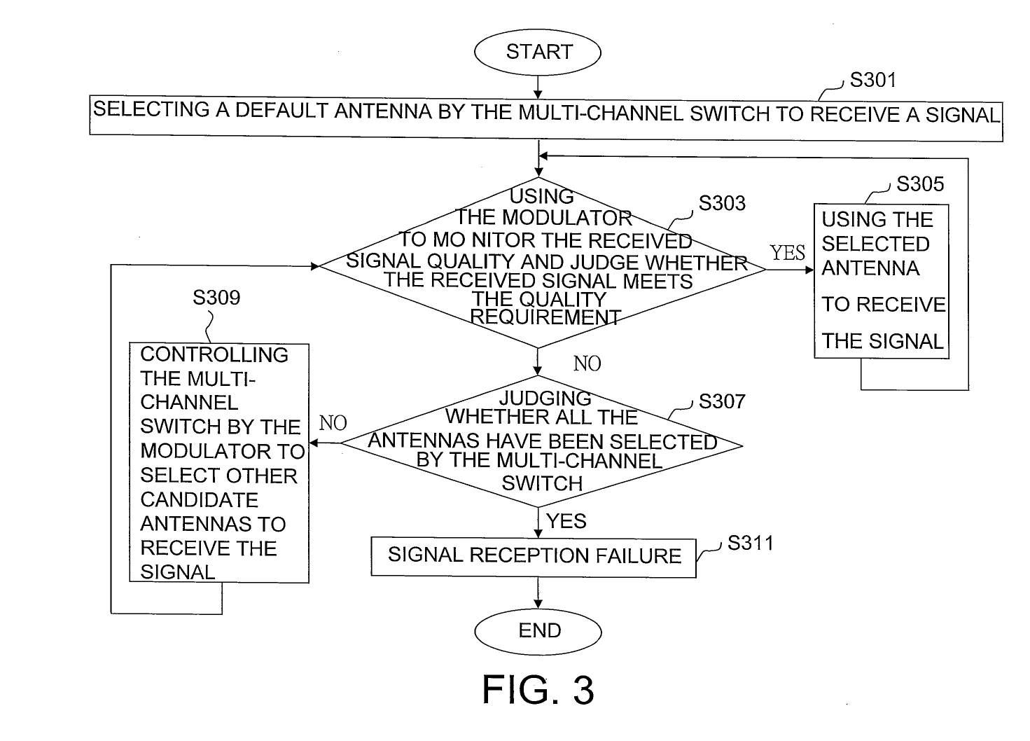

FIG. 3 is the flowchart of the wireless communication receiving method according to the preferred embodiment of the present invention. Referring to FIG. 3, in the embodiment, a demodulator is used to monitor the received signal quality for judging whether the received signal meets the quality requirement so as to decide whether the MS needs to select the signals received by other antennas. The steps of the method are described as follows.

First, the MS selects a default antenna to receive a signal (step S301).

Next, the received signal of the antenna is input to a tuner for tuning, followed by sending the tuned signal to the demodulator. The demodulator monitors quality of the received signal and judges whether the received signal meets the quality requirement (step S303). For example, in DVB-T communication, the quality requirement may mean, but not limited to, that based on the transport stream output from the demodulator, the next-stage decoder may recover the originally transmitted frames. If the received signal meets the quality requirement according to the judgment of the demodulator, the selected antenna corresponding to the quality-qualified signal is kept in use for outputting signals for decoding (step S305) and the procedure flow goes back to step S303.

If the received signal fails to meet the quality requirement, it would be judged whether all the antennas have been selected by the MS (step S307). If not all the antennas have been selected by the MS, the demodulator would control the MS to select other candidate antennas to receive the signal (step S309) and the procedure flow goes back to step S303.

If all the antennas have been selected by the MS, that is to say, the signal reception is failed (step S311) and the procedure flow ends up.

Once the received signals of all the antennas fail to meet the quality requirement so to recognize failure of the signal reception, the wireless communication receiver is able to restart the above-described procedure flow after a suitable interval. The detail implementation manner for deciding the suitable interval is not particularly specified, as long as the goal of the present invention is achieved.

In summary, the present invention has the advantages, not only to gain the expected benefit of the multi-antenna scheme, but also to reduce the receiver size and lower the power-consumption of the receiver. Therefore, the present invention is applicable to a mobile multimedia device with a display unit, for example, a notebook computer, a portable television, a mobile phone handset, a digital camera, a digital camcorder, a vehicle television and a personal digital assistant (PDA).

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A wireless communication receiver, coupled to a plurality of antennas;
the wireless communication receiver comprising:
a multi-channel switch, coupled to the antennas for receiving and delivering an output signal from one of the antennas;
a tuner, used for tuning an output signal of the multi-channel switch; and
a demodulator, used for demodulating an output signal of the tuner to generate a transport stream, wherein the demodulator further generates a control signal according to the output signal of the tuner, and the multi-channel switch decides whether to select an output signal of another antenna according to the control signal.

2. The wireless communication receiver according to claim 1, wherein the demodulator uses a bit error rate-monitoring function to generate the control signal.

3. A wireless communication receiver, coupled to a plurality of antennas;
the wireless communication receiver comprising:
a multi-channel switch, coupled to the antennas for selecting and delivering an output signal from one of the antennas; and
a network interface module, used for receiving an output signal of the multi-channel switch and tuning and demodulating the received signal to generate a transport stream and further judging the quality of the signal output from the antenna currently selected by the multi-channel switch.

4. The wireless communication receiver according to claim 3, wherein the network interface module comprises:
a tuner, coupled to the multi-channel switch for tuning the output signal of the multi-channel switch.

5. The wireless communication receiver according to claim 4, wherein the network interface module further comprises:
a demodulator, coupled to the tuner for demodulating an output signal of the tuner to generate the transport stream, wherein the demodulator generates a control signal sent to the multi-channel switch according to the output signal of the tuner and the multi-channel switch decides whether to select an output signal of another antenna according to the control signal.

6. The wireless communication receiver according to claim 5, wherein the demodulator uses a bit error rate-monitoring function to generate the control signal.

7. A wireless communication receiving method, comprising the following steps:
selecting an antenna from an antenna group to receive a signal;
tuning and demodulating an output signal of the selected antenna; and
monitoring the quality of the output signal of the antenna and judging whether the received signal meets the quality requirement to decide whether using the output signal of the selected antenna in decoding or selecting an output signal of another antenna from the antenna group.

8. The wireless communication receiving method according to claim 7, wherein the step for judging the signal quality comprises:
using a bit error rate-monitoring function to conduct the judgement.

9. The wireless communication receiving method according to claim 7, wherein the step for judging the signal quality comprises:
if the quality meets the quality requirement, using the output signal of the antenna in decoding; and
if the quality does not meet the quality requirement, selecting an output signal of another antenna from the antenna group.
